(19) United States
(12) Patent Application Publication
(10) Pub. No.: US 2024/0385412 A1
(43) Pub. Date: Nov. 21, 2024

(54) MIRROR DEVICE FOR A HEAD-UP DISPLAY WITH SPECIFIC AIR BUBBLE REDUCTION IN THE MIRROR REGION, AS WELL AS A HEAD-UP DISPLAY AND MOTOR VEHICLE

(71) Applicant: VALEO SCHALTER UND SENSOREN GMBH, Bietigheim-Bissingen (DE)

(72) Inventor: Loic Le Toumelin, Bietigheim-Bissingen (DE)

(73) Assignee: VALEO SCHALTER UND SENSOREN GMBH, Bietigheim-Bissingen (DE)

(21) Appl. No.: 18/689,717

(22) PCT Filed: Sep. 5, 2022
(86) PCT No.: PCT/EP2022/074561

§ 371 Date: Mar. 6, 2024

(30) Foreign Application Priority Data
Sep. 7, 2021 (DE) 10 2021 123 115.9

(51) Int. Cl. G02B 7/182; G02B 27/01

(52) U.S. Cl. CPC G02B 7/182; G02B 27/0172

(57) ABSTRACT

A mirror device for a head-up display is disclosed. The mirror device includes a mirror, an adhesive element which is arranged on a rear side of the mirror, and a carrier which is connected to the adhesive element. The carrier has a front side which faces the adhesive element and in which openings of air discharge ducts are arranged. The air discharge ducts are formed in the carrier. The adhesive element has at least one through hole, with which an interface region between the rear side of the mirror and a front side of the adhesive element is fluid-conductively connected to an air discharge duct.

One aspect of the invention relates to a mirror device for a head-up display. The mirror device has a mirror. The mirror has a rear side. The mirror device also has an adhesive element. This is located on the rear side of the mirror. The mirror device also has a carrier. The carrier is connected to the adhesive element. The carrier has a front side facing the adhesive element. On said front side, the carrier has openings of air discharge ducts. Said air discharge ducts are formed in the carrier. Another aspect of the invention relates to a head-up display for a motor vehicle with a mirror device. Yet another aspect of the invention relates to a motor vehicle with a head-up display.

Head-up displays in motor vehicles usually have a housing. This can be formed from a plurality of subregions. In this context, it can have a cover module and a base module, for example. These two components can be joined together. Plug connections or snap connections or screw connections and the like can be provided here, for example. In this regard, the cover module has an outer housing. The base module can likewise have an outer housing. These two parts in the form of the outer housings or the shells then also form the overall housing of the head-up display. In this regard, they are therefore external visible components of the head-up display. An image generating unit is usually arranged in a head-up display. This generates the images, which can be projected by means of the head-up display onto an external projection surface, such as a window pane of the motor vehicle. In addition, a head-up display has at least one mirror in the interior of the housing. The light beams generated by the image generating unit are reflected by this mirror. In head-up displays, it is also possible, however, to envisage the installation of two separate mirrors in the interior of the housing. As a result, multiple deflection or multiple reflection of the light beams generated by the image generating unit is performed. In this case, a first mirror, which is arranged closer to the image generating unit in the beam path from the image generating unit to an exit window of the head-up display, is also referred to as a fold mirror. With the second mirror arranged downstream of the beam path with respect thereto, the light beams are deflected, in particular toward this exit window of the head-up display. To enable the light deflection and thus the light emission to be performed very precisely, and since sharp image representation is therefore also possible, a very precise arrangement of the mirrors in the housing, in particular of a mirror which is first in this regard, is required.

In the case of mirror devices for a head-up display, as explained above, there may be air inclusions between the mirror and the adhesive element. These may adversely affect the optical properties of the mirror. In addition, the mechanically stable fastening or the connection between the adhesive element and the mirror may thereby be impaired.

It is an object of the present invention to provide a mirror device for a head-up display in which air inclusions between the mirror and an adhesive element can be better avoided. Furthermore, it is an object to provide a head-up display with such a mirror device. It is also an object to provide a motor vehicle with a head-up display.

One aspect of the invention relates to a mirror device for a head-up display. The mirror device has a mirror. The mirror has a rear side. The mirror device also has an adhesive element. This is located on the rear side of the mirror. The mirror device also has a carrier. The carrier is connected to the adhesive element. The carrier has a front side facing the adhesive element. On said front side, the carrier has openings of air discharge ducts. Said air discharge ducts are formed in the carrier.

The adhesive element has at least one through hole. An interface region between the rear side of the mirror and a front side of the adhesive element is fluid-conductively, in particular gas-conductively, connected by said at least one through hole in the adhesive element to an air discharge duct which is formed in the carrier. By means of such continuous holes in the adhesive element, it is thus made possible for an air inclusion which is formed between the front side of the adhesive element and the rear side of the mirror to be removed from said interface region. This is because such an air inclusion can then pass behind the adhesive element through the through hole. In addition, since said through hole is fluid-conductively connected to an air discharge duct, it is thus also easily made possible for said air not to remain in the interface region between the adhesive element and the carrier. On the contrary, it is thereby also possible in a very defined and directed way to discharge said air from said interface region between the rear side of the adhesive element and the front side of the carrier. This means that said air can also be led out of the carrier on this predetermined, targeted discharge path. This makes possible a particularly efficient concept to avoid or at least to efficiently eliminate air inclusions between the adhesive element and the mirror. The improvement in the mirror device with regard to its optical imaging properties, on the one hand, and in particular also with regard to the mechanically improved connection between the mirror and the adhesive element, on the other hand, is thus made possible.

In one exemplary embodiment, the adhesive element is in the form of a double-sided adhesive tape. This is a highly advantageous exemplary embodiment. This is because it is thereby possible to avoid liquid adhesives from being used as an adhesive element. Such a double-sided adhesive tape already exists as an element which is produced by itself before being installed. It is already present as a shape-preserving component before it is installed on the mirror or between the mirror and the carrier. This is a significant advantage in terms of handling and attaching to the components mentioned. Such an exemplary embodiment is particularly advantageous in that through holes can be produced on the adhesive element in a defined manner even before it is installed. An adhesive element is therefore already formed with at least one such through hole before is installed on the carrier and/or on the rear side of the mirror. A double-sided adhesive tape also makes it possible for the size of a through hole and/or the position of a through hole on said adhesive element to be very precisely produced. This in turn also has advantages for producing the fluid-conducting connection of the through hole with at least one air discharge duct during the assembly. In addition, such a double-sided adhesive tape is also advantageous in terms of installation. This is because very rapid and precise installation is possible. In addition, a stable mechanical connection to the components then being connected directly, in particular to the rear side of the mirror and the front side of the carrier, is possible. A permanently stable connection is thus also achieved.

In one exemplary embodiment, at least one air discharge duct is open on the front side of the carrier over at least 50 percent, in particular at least 75 percent, in particular at least 90 percent, of its length which is measured along its longitudinal axis. Thus, an air discharge duct is open linearly on its side facing the rear side of the adhesive element. This further improves the air discharge concept. This is in particular because the hole width of a through hole is larger than, in particular, only an inlet of such an air discharge duct. Perpendicularly to its longitudinal axis, the air discharge duct has a cross section in this respect. In this respect, the inlet of the air discharge duct is defined at its start. Said cross section is smaller than the size of the through hole. Therefore, if only the inlet of an air discharge duct on the front side of the carrier is exposed, a fluid-conducting bottleneck would result. The air discharge therefore appears to be restricted at this point. Since, however, the advantageous exemplary embodiment causes the air discharge duct, when viewed along its longitudinal axis, to be open over this larger length, that surface via which air coming from the through hole can penetrate into said air discharge duct is thus also enlarged. The air discharge concept has thus been further improved. This means that there is virtually no bottleneck at the interface between the through hole and the air discharge duct either and a larger volume of air can immediately enter the air discharge duct and be discharged there.

In one exemplary embodiment, the at least one air discharge duct is in the form of a channel. This is preferably open over its entire length on the front side of the carrier. The abovementioned advantages are thus supported once again. This as well as the exemplary embodiment mentioned directly above is highly advantageous also with regard to the manufacturing of the carrier. This is because since said air discharge ducts are open toward the front side, they can also be easily produced. For example, the carrier in this context can be formed from plastic. For example, it can be implemented as an injection molded component. The air discharge ducts therefore do not have to be produced completely internally in the carrier in these abovementioned exemplary embodiments. The production of said air discharge ducts close to the surface and with their openings along their longitudinal axis toward the front side of the carrier is thus also easier.

When looking at the front of the carrier and thus at the front side, the at least one air discharge duct, in particular a plurality of air discharge ducts, are designed as grooves or channels in this exemplary embodiment.

In one exemplary embodiment, at least two air discharge ducts are spaced apart and oriented parallel to one another. This allows air to be discharged at a plurality of points on the front side. It is also possible to simultaneously discharge any trapped air via a plurality of separate air discharge ducts. In addition, this exemplary embodiment also affords the possibility that air discharge ducts are present at different local points on the front side of the carrier. Locally trapped air at the interface between the adhesive element and the mirror can then be moved closer to an adjacent air discharge duct via a through hole. This means that air possibly trapped locally at this interface between the adhesive element and the mirror may not have to be moved over a relatively long distance between the adhesive element and the mirror in order in this regard to be able to reach a remote air discharge duct.

In one exemplary embodiment, at least two air discharge ducts are formed running in the transverse direction of the carrier. In one exemplary embodiment, at least two air discharge ducts are arranged running in the vertical direction of the carrier. In this context, in one exemplary embodiment, the front side of the carrier is formed as an angular, in particular quadrangular, surface. Said surface is preferably curved, in particular concavely. Such a quadrangular surface is thus bounded by four side edges. In each case two opposite side edges are spaced apart in this context in the transverse direction, on the one hand, and in the vertical direction, on the other. This also means that at least two air discharge ducts extend in this one transverse direction between two opposite border edges of the carrier, in particular the surface of the front side. The at least two other air discharge ducts extend in this respect between the two other opposite edges of the front side of the carrier, with here the direction of extent then being the vertical direction.

In particular, the air discharge ducts are formed without interruption over their corresponding longitudinal extent.

By means of such an air discharge duct pattern with at least two air discharge ducts in one direction of extent and at least two air discharge ducts in another direction of extent, the discharge of locally trapped air between an adhesive element and the mirror can be achieved better even locally. In addition, the air discharge concept has also been improved accordingly, since even larger amounts of air can be discharged more rapidly. Said amounts of air can be distributed simultaneously in the plurality of air discharge ducts and can then also be discharged simultaneously.

In one exemplary embodiment, at least one first air discharge duct and at least one second air discharge duct different thereto cross at a duct intersection. Said two air discharge ducts oriented in different directions are thus fluid-conductively coupled in particular at least at said duct intersection. At said duct intersection, the air discharge ducts merge. Owing to such an interface in the form of the duct intersection, it is also particularly advantageously possible to introduce air into the air discharge ducts and to distribute it as extensively as possible simultaneously to a plurality of air discharge ducts.

In one exemplary embodiment, at least one through hole, which is formed in the adhesive element, is arranged in the region of the at least one duct intersection, and therefore the duct intersection is exposed toward the rear side of the mirror. This location positioning between the through hole, on the one hand, and such a duct intersection, on the other hand, makes it possible in a particularly advantageous manner to move trapped air between the adhesive element and the rear side of the mirror through a through hole and then immediately there on the shortest route into the duct intersection. A particularly efficient and short-range air discharge concept is thus achieved.

In one exemplary embodiment, a plurality of air discharge ducts are arranged in a matrix-like duct arrangement pattern. Such a matrix-like arrangement particularly supports the abovementioned advantages. The locally targeted and rapid discharge of trapped air between the adhesive element and the rear side of the mirror, on the one hand, and a particularly advantageous simultaneous discharge of trapped air via a plurality of air discharge ducts, even in different discharge directions, is thus assisted.

A matrix-like duct arrangement or a corresponding duct arrangement pattern may have a plurality of rectilinear first air discharge ducts oriented parallel to one another and have a plurality of rectilinear further air discharge ducts, which are oriented parallel to one another, in particular at an angle of 90° to the other air discharge ducts. Thus, a matrix-like duct arrangement pattern, in which a plurality of air discharge ducts are formed virtually perpendicularly to one another, is produced.

In one exemplary embodiment, an outlet of such an air discharge duct, said outlet being formed at one end of an air discharge duct, is formed at an edge or border edge of the carrier, and therefore discharged air exits from the carrier laterally to the front side of the carrier. This is also a highly advantageous exemplary embodiment, because the air guidance concept is thus carried out in such a way that once air has entered the air discharge duct, it is no longer recirculated into the interface region between the adhesive element and the mirror or can no longer reach there. It is precisely this lateral edge-side discharge that also allows the air to escape quickly and extensively out of the air discharge ducts. Since there is usually a larger air space in a head-up display, especially in the vicinity of this edge of the carrier, the exit of air specifically at this point is also not undesirably impaired or a corresponding build up of the exit of air occurs. All this can be correspondingly avoided. In addition, this air exit point also prevents the escaping air from being able to reach the front of the mirror of the mirror device and thus being able to impair the optical imaging property if undesired turbulence of the escaping air were to possibly arise there. Since said exit of air from the air discharge ducts is thus carried out behind the mirror of the mirror device, such disadvantages, if any occur, can be avoided.

In one exemplary embodiment, the surface of the adhesive element covers at least 70 percent, in particular at least 80 percent, of the surface of the front side of the carrier. Thus, the air discharge ducts, which are preferably open toward the front side of the carrier, are also extensively covered by the adhesive element.

It may be provided, in one exemplary embodiment, that a flat edge strip of the front side of the carrier is not covered by the adhesive element. In this edge strip, at least one air discharge duct may be open on the front side, in one exemplary embodiment. This means that it is then additionally also possible that air can be discharged via this side region of the air discharge duct. This is then discharged into the intermediate space between the front side of the carrier and the rear side of the mirror. This can be carried out in addition to the abovementioned exemplary embodiment by a corresponding discharge of air guided in an air duct taking place only via one edge side of the carrier.

In one exemplary embodiment, the adhesive element has a plurality of separate through holes. A through hole may have a corner-free contour edge with respect to its geometry. However, other geometries are also possible. In this respect, a through hole may be circular or oval or the like. Angular contour edges for defining the geometry of a through hole are also possible.

Another aspect of the invention relates to a head-up display with a mirror device according to the abovementioned aspect or an advantageous exemplary embodiment thereof. In particular, the head-up display is a windshield head-up display. This means that the light coupled out from the head-up display is projected onto a windshield. In one exemplary embodiment, the head-up display has a housing in which the mirror device is arranged. This housing may also contain an image generating unit of the head-up display. It is also possible for the head-up display to have a first mirror device. This first mirror device may be formed according to the abovementioned aspect or an advantageous exemplary embodiment thereof. The head-up display may only have a single mirror device. In one exemplary embodiment, it is also possible for a head-up display to have a first mirror device and a second mirror device which is separate therefrom. In this concept, the light of the image generating unit is projected, when viewed along the beam path, firstly onto the first mirror device and reflected via said first mirror device to the following second mirror device in the beam path. From the second mirror device, the light is then reflected in the direction of an exit window of the head-up display and radiated out of this exit window from the head-up display, in particular directly onto an inside of a windshield of a motor vehicle. It may be provided in such an exemplary embodiment that the first mirror device and/or the second mirror device is or are formed according to the abovementioned aspect or an advantageous exemplary embodiment thereof.

Another aspect of the invention relates to a motor vehicle with a head-up display according to the abovementioned aspect or an advantageous exemplary embodiment thereof.

Exemplary embodiments of the invention will be discussed in more detail below on the basis of schematic drawings. In the drawings:

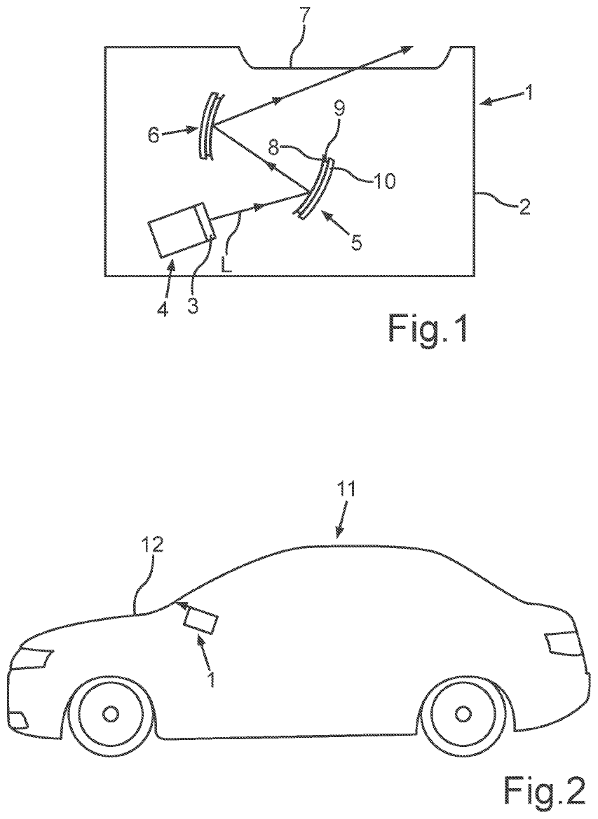

FIG. 1 shows a schematic illustration of an exemplary embodiment of a head-up display according to the invention;

FIG. 2 shows a schematic illustration of an exemplary embodiment of a motor vehicle according to the invention;

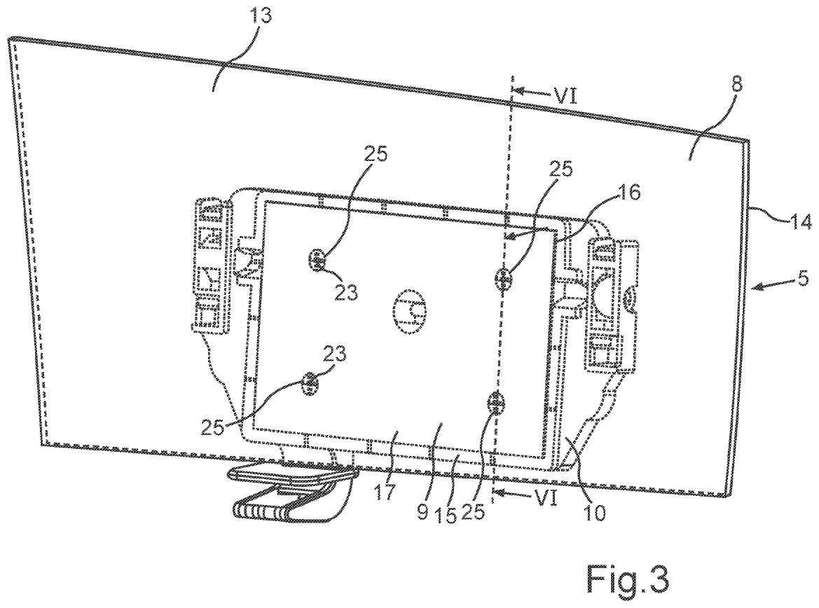

FIG. 3 shows a perspective illustration of an exemplary embodiment of a mirror device according to the invention for a head-up display;

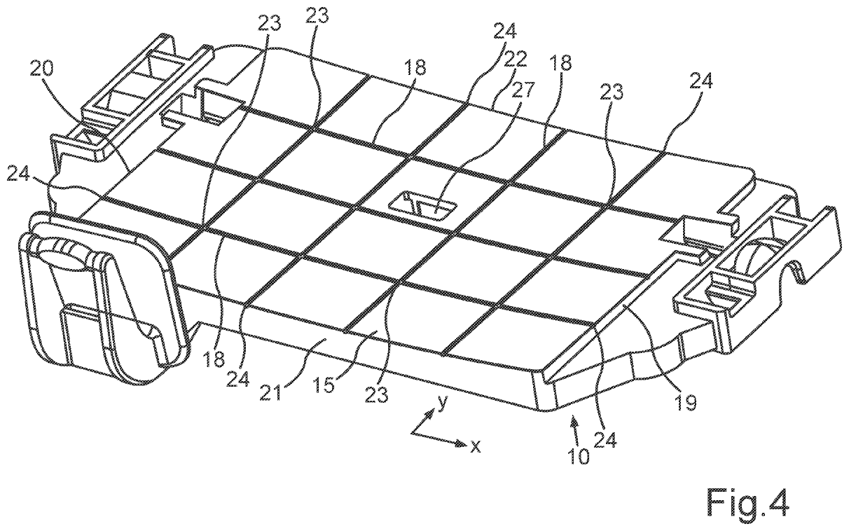

FIG. 4 shows a perspective illustration of an exemplary embodiment of a carrier of the mirror device according to FIG. 3;

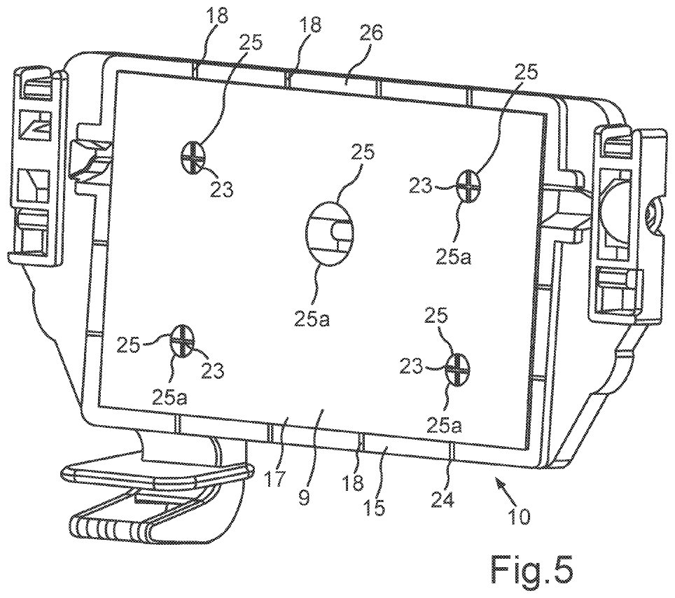

FIG. 5 shows a perspective illustration of a carrier with an adhesive element of the mirror device, which is applied to a front side of the carrier, according to FIG. 3; and

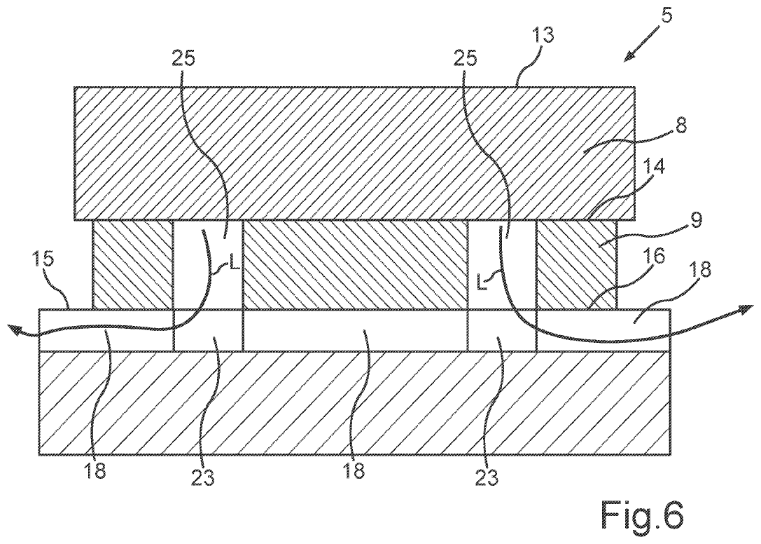

FIG. 6 shows a simplified sectional illustration through the mirror device according to FIG. 3.

In the figures, identical or functionally identical elements are provided with the same reference signs.

In FIG. 1, an exemplary embodiment of a head-up display 1 is shown in a schematic illustration. The head-up display 1 is provided as specified for installation in a motor vehicle. The head-up display 1 here is a windshield head-up display.

The head-up display 1 has a housing 2. In a schematic illustration, at least one image generating unit 4, in particular with a display 3, is arranged in the housing 2. In addition, the head-up display 1 has a mirror device 5. In one exemplary embodiment, the head-up display 1 may have only the one mirror device 5. In another exemplary embodiment, shown here in FIG. 1, the head-up display 1 may have a further mirror device 6. The one mirror device, also referred to as first mirror device 5, is arranged in the beam path of the light L, which is radiated from the image generating unit 4, in front of the further mirror device, referred to as second mirror device 6. The light L of the image generating unit 4 is reflected from the first mirror device 5 to the second mirror device 6. The light L is then reflected from the second mirror device 6 to an exit window 7 and exits from the housing 2 there.

In one exemplary embodiment, a mirror device of a head-up display 1 has a mirror, an adhesive element and a carrier. These components may be provided in the first mirror device 5. They may also be provided additionally or instead in the second mirror device 6.

For example, the first mirror device 5 may have a mirror 8, an adhesive element 9 and a carrier 10. The mirror 8 is a reflection element.

FIG. 2 shows an exemplary embodiment of a motor vehicle 11 in a schematic illustration. The motor vehicle 11 may be, for example, a passenger car. However, it may also be a truck. The motor vehicle 11 has a head-up display 1. This is designed according to an exemplary embodiment, as has been explained with regard to FIG. 1. The light L, which exits from the exit window 7, is projected onto a windshield 12 of the motor vehicle 1.

FIG. 3 shows a mirror device in one exemplary embodiment. This is the mirror device 5 by way of example here. It has the mirror 8, which has already been discussed. The mirror 8 is curved. In particular, it is a concave mirror. This means that a reflective front side 13 is curved concavely. The light L hits the front side 13 and is reflected accordingly. In addition, the mirror 8 has a rear side 14. Furthermore, the adhesive element 9 can also be seen here. This is attached, in particular adhesively bonded, directly to the rear side 14 in the exemplary embodiment. The adhesive element 9 is a double-sided adhesive tape in one exemplary embodiment. In addition, the carrier 10 can also be seen in FIG. 3. The carrier 10 may be formed in an exemplary embodiment of plastic. It is preferably in one piece. For example, it can be implemented as an injection molded component. As can already be seen in FIG. 3, the adhesive element 9 is arranged between the mirror 8 and the carrier 10. In this context, a front side 15 of the carrier 10 is arranged directly on a rear side 16 of the adhesive element 9. A front side 17 of the adhesive element 9 is arranged directly on the rear side 14.

As can be seen in FIG. 4, in which the carrier 10 is shown in a perspective illustration, the carrier 10 has at least one air discharge duct. Preferably, a plurality of air discharge ducts 18 are formed here, only some of which are provided with the corresponding reference sign, in order to maintain the clarity. In the exemplary embodiment, the air discharge ducts 18 are open toward the front side 15. In particular, the air discharge ducts 18 are each open over their entire length toward the front side 15. As a result, the air discharge ducts 18 are designed here in the manner of channels or grooves. As can be seen, a plurality of separate air discharge ducts 18 are integrally formed in the carrier 10. In this context, a plurality of air discharge ducts 18 are each oriented parallel to one another. In one exemplary embodiment, at least two air discharge ducts 18 are formed running in a transverse direction (x direction) of the carrier 10. In this respect, they extend continuously and without interruption from a first edge 19 to a further edge 20 lying opposite in said transverse direction. In one exemplary embodiment, further, in particular at least two, air discharge ducts 18 are arranged running in a further spatial direction, here in the vertical direction (y direction) of the carrier 10. In this context, they also extend without interruption in said vertical direction. In this respect, they extend between further edges 21 and 22 of the carrier 10, in particular of the front side 15.

In the exemplary embodiment, the plurality of air discharge ducts 18 are arranged in a matrix-like duct arrangement pattern. Here, the air discharge ducts 18 are oriented at an angle of 90° to one another.

In addition, at least a few air discharge ducts 18 are designed such that they cross at least one further air discharge duct 18. This results in duct intersections 23. Here too, for the sake of clarity, only some of these duct intersections 23 are provided with the corresponding reference sign.

The duct intersections 23 are also open on the front side 15.

As can be seen in addition, the air discharge ducts 18, when viewed along their longitudinal axis, in each case have end-side outlets. In FIG. 4, here too in turn, for the sake of clarity, only some of these outlets 24 are provided with the corresponding reference sign. The outlets 24 are formed at the edges 19, 20, 21 and 22 in the exemplary embodiment shown. Thus, air, which is discharged in an air discharge duct 18, can be discharged laterally from the carrier 10 via these outlets 24.

In FIG. 5, the carrier 10 according to FIG. 4 is shown in a perspective illustration. In addition, the flat adhesive element 9 is attached, in particular adhesively bonded, to the front side 15. As can be seen in FIG. 5 and is also already shown in FIG. 3, the adhesive element 9 has at least one through hole 25. In particular, in the exemplary embodiment, there are a plurality of separate through holes 25 formed spaced apart from one another. In the exemplary embodiment, the adhesive element 9 covers the surface of the front side 15 at least by 50 percent, in particular at least by 60 percent, in particular at least by 70 percent, in particular at least by 80 percent. In the exemplary embodiment, the positioning of the adhesive element 9 is such that a peripheral edge strip 26 of the front side 15 is not covered by the adhesive element 9. In the exemplary embodiment, it is provided that, in this edge strip 26, at least some of the air discharge ducts 18 are open toward the front side 15. This also enables air to exit not only via the outlets 24, but also via said partial sections of the air discharge ducts 18, toward the front and thus in particular toward the rear side 14 of the mirror 8.

As can be seen in FIG. 5, the through holes 25 are positioned in such a way that they are formed or are arranged in a projection view on the surface regions at which duct intersections 23 are present.

It is also possible for the carrier 10 to have a hole 27, as shown in FIG. 4. This hole 27 is continuous. It may be provided, in one exemplary embodiment, that in particular a central through hole 25 is arranged in the surface region of said hole 27. As a result, air can also flow away through the through hole 25 directly into said hole 27.

If air is now positioned in the interface region between the front side 17 of the adhesive element 9 and the rear side 14 of the mirror 8, in particular, for example, is trapped as an air bubble, this trapped air can easily be discharged from this interface region. Thus, it is possible in this context for said trapped air to reach a through hole 25 and to be discharged from there directly, since the duct intersection 23 is exposed toward the rear side 14, into at least one air discharge duct 18.

Via said at least one air discharge duct 18, the air is then conducted away and thus, in particular, conducted out of the carrier 10. In this context, a simplified sectional illustration of the mirror device 5 along the sectional line VI-VI in FIG. 3 is shown in FIG. 6.

The flow path of air L is shown by way of example.

1. A mirror device for a head-up display, the mirror device comprising:
a mirror;
an adhesive element which is arranged on a rear side of the mirror; and
a carrier which is connected to the adhesive element,
wherein the carrier has a front side which faces the adhesive element and in which openings of air discharge ducts are arranged,
wherein the air discharge ducts are formed in the carrier, and wherein the adhesive element comprises at least one through hole, with which an interface region between the rear side of the mirror and a front side of the adhesive element is fluid-conductively connected to an air discharge duct.

2. The mirror device as claimed in claim 1,
wherein the adhesive element is a double-sided adhesive tape.

3. The mirror device as claimed in claim 1,
wherein at least one air discharge duct is open on the front side of the carrier over at least 90%, of its length.

4. The mirror device as claimed in claim 3,
wherein the at least one air discharge duct is in the form of a channel which is open over its entire length on the front side of the carrier.

5. The mirror device as claimed in claim 1,
wherein at least two air discharge ducts are oriented parallel to one another.

6. The mirror device as claimed in claim 1,
wherein at least two air discharge ducts are formed running in the transverse direction of the carrier and at least two air discharge ducts are arranged running in the vertical direction of the carrier.

7. The mirror device as claimed in claim 1,
wherein at least one first air discharge duct and at least one second air discharge duct cross at a duct intersection and are fluid-conductively coupled.

8. The mirror device as claimed in claim 7,
wherein the through hole is arranged in the region of the duct intersection, and therefore the duct intersection is exposed toward the rear side of the mirror.

9. The mirror device as claimed in claim 1,
wherein a plurality of air discharge ducts are arranged in a matrix-like duct arrangement pattern.

10. The mirror device as claimed in claim 1,
wherein an outlet of an air discharge duct is formed at one end of an air discharge duct,
wherein the outlet of the air discharge duct is formed at an edge of the carrier, and therefore discharged air exits from the carrier laterally to the front side of the carrier.

11. The mirror device as claimed in claim 1,
wherein the surface of the adhesive element covers at least 80%, of the surface of the front side.

12. The mirror device as claimed in claim 11,
wherein an edge strip of the front side of the carrier is not covered by the adhesive element and,
wherein in the edge strip, at least one air discharge duct is open on the front side.

13. The mirror device as claimed in claim 1,
wherein the adhesive element comprises a plurality of separate through holes with a corner-free contour edge.

14. A head-up display with a mirror device as claimed in claim 1.

15. A motor vehicle with a head-up display as claimed in claim 14.
